(19) United States
(12) Patent Application Publication
(10) Pub. No.: US 2010/0176524 A1
(43) Pub. Date: Jul. 15, 2010

(54) METHOD AND APPARATUS FOR NANOPOWDER AND MICROPOWDER PRODUCTION USING AXIAL INJECTION PLASMA SPRAY

(75) Inventors: Alan W. Burgess, North Vancouver (CA); Nikica Bogdanovic, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Northwest Mettech Corporation, North Vancouver, BC (CA)

(21) Appl. No.: 12/294,976

(22) PCT Filed: Mar. 29, 2007
(86) PCT No.: PCT/CA2007/000514

§ 371 Date: Nov. 19, 2008

Related U.S. Application Data
(60) Provisional application No. 60/786,702, filed on Mar. 29, 2006.

(51) Int. Cl. B29B 9/10

(52) U.S. Cl. 264/12; 425/7; 977/840

(57) ABSTRACT

A method and system for production of powders, such as micropowders and nanopowders, utilizing an axial injection plasma torch. Liquid precursor is atomized and injected into the convergence area of the plasma torch. The hot stream of particles is subsequently quenched and the resultant powders collected.

### TECHNICAL FIELD

The invention relates to the field of nanopowder and micropowder production using plasma spray torches.

### BACKGROUND

Nanopowders are powders composed of particles having a diameter between about 1 and 100 nanometers (10⁻⁹ m. to 10⁻⁷ m.). Nanopowders are replacing conventional powders in many applications because of their unique properties, such as higher surface area and easier formability, and because of improved performance of end products. Some current applications of nanopowders are catalysts, lubricants, abrasives, explosives, sunscreen and cosmetics. Micropowders are powders composed of particles having a diameter between about 100 nanometers and 10 microns (10⁻⁷ m. to 10⁻⁵ m.). Micropowders encompass submicropowders which have a diameter between about 100 nanometers and 1 micron (10⁻⁷ m. to 10⁻⁶ m.). Micropowders also have many useful current applications.

Various methods are currently used to produce nanopowders. One method currently used to produce metal oxide nanopowders is mechanochemical processing in which dry milling induces chemical reactions which form nanoparticles in a salt matrix. Another method involves a vapor process in which vaporization of the material is followed by rapid condensation to produce particles of the required size. International applications No. WO 03/097521, WO 2004/052778 (US2003/0143153), WO 2004/056461, WO 03/097521 and WO 02/086179 disclose the use of plasma jets for producing nanopowder. The difficulty with present methods is in forming particles of uniformly small diameter which do not agglomerate during condensation.

U.S. Pat. No. 7,125,537 Liao et al. discloses a method of producing nanopowders using a plasma torch, by introducing a solid precursor to the plasma-convergence section of the plasma torch, wherein the solid precursor is vaporized and oxidized before being sprayed out with the plasma jet, and obtaining nanopowders by blowing the plasma jet containing the vaporized and oxidized precursor through a vortical cooling-gas.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method and system for production of powders, including micropowders and nanopowders, utilizing an axial injection plasma torch. Liquid precursor is atomized and injected into the plasma where it undergoes chemical and physical transformations in a controlled fashion resulting in a desired product, which is then collected.

More particularly, the invention provides a method of manufacturing nanopowders or micropowders, comprising: i) providing an axially injected plasma torch comprising a convergence chamber; ii) axially delivering a liquid precursor to the plasma torch; iii) atomizing the liquid precursor prior to delivery to the convergence chamber thereby forming a hot stream of particles in the plasma stream generated by the torch; iv) introducing the hot stream of particles into a chamber; v) introducing a quenching gas into the chamber at a quenching location; vi) cooling the hot stream of particles and collecting the powder thereby produced.

The invention also provides a system for manufacturing nanopowders or micropowders comprising: i) feed means for delivering a liquid precursor; ii) an axially injected plasma spray torch comprising a convergence chamber; atomizing means for atomizing said liquid precursor prior to delivery to the convergence chamber thereby forming a hot stream of particles in the plasma stream generated by the torch; iv) a chamber for reaction of the hot stream of particles with a quenching gas; v) means for introducing the quenching gas to the chamber at a quenching location; and vi) means for collecting the nanopowders or micropowders thereby produced.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic view of a system constructed according to the invention.

FIG. 2 is a process flow diagram for a system constructed according to the invention.

FIG. 3 is a cross-section view of an atomizer which may be used in the invention.

FIG. 4 is a plan view of the reaction chamber according to the invention.

FIG. 5 is a detail cross-section view of an injection port in the reaction chamber shown in FIG. 4.

FIG. 6 is a perspective view, partially cut away, of the axial injection plasma torch used in the invention.

FIG. 7A is a cross-section view showing the back face of the convergence area of the axial injection plasma torch taken along lines A-A of FIG. 6.

FIG. 7A is a cross-section view of the convergence area of the axial injection plasma torch taken along lines B-B of FIG. 7A.

FIG. 7A is a cross-section view showing the front face of the convergence area of the axial injection plasma torch taken along lines C-C of FIG. 6.

FIG. 7D is a side elevation view of the convergence area of the axial injection plasma torch.

FIG. 8 is a plan view of a second embodiment of the reaction chamber according to the invention.

FIG. 9 is an exploded plan view of a second embodiment of the reaction chamber shown in FIG. 8.

FIG. 10 is an elevation view of a hot shroud used in the invention.

FIG. 11 is a schematic illustration of a powder collection system.

FIG. 12 is a cross-section view of a nozzle for a further variant of the atomizer which may be used in the invention.

FIG. 13 is a cross-section view of the nozzle of FIG. 12 installed in the liquid delivery apparatus.

FIG. 14 is a perspective view of the atomizer of FIG. 13 installed in the convergence section of the torch.

FIG. 15 is a cross-section view of the atomizer shown in FIG. 14.

FIG. 16 is a schematic diagram illustrating the flow of powders and gasses in the reaction chamber.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

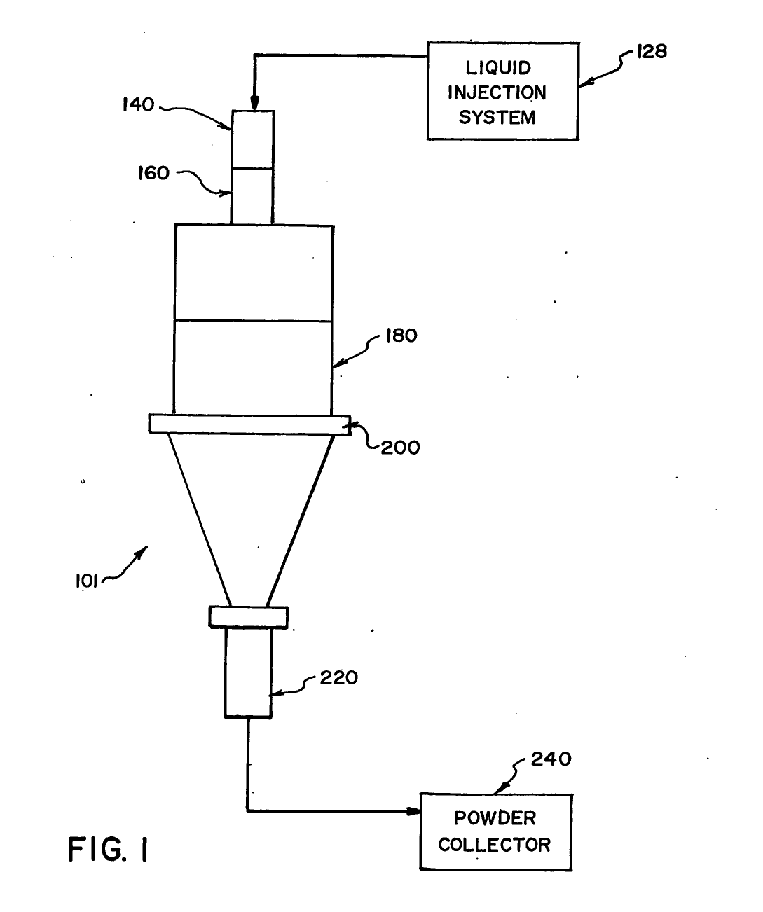

As illustrated schematically in FIG. 1, the invention comprises a nanopowder and micropowder production system 101 comprising a liquid precursor injection system 128 for feeding of various salt solutions containing the reactant constituents required to make the nanopowders and micropowders. The liquid precursor injection system 128 comprises an atomizer which is fitted into an axial injection plasma torch 140. The system also comprises a hot shroud 160, chamber 180, gas injection flange 200, hot shroud quenching system 220 and powder collection system 240. The diameter of chamber 180 may be from 2 inches to 36 inches, depending on the size of powders to be produced.

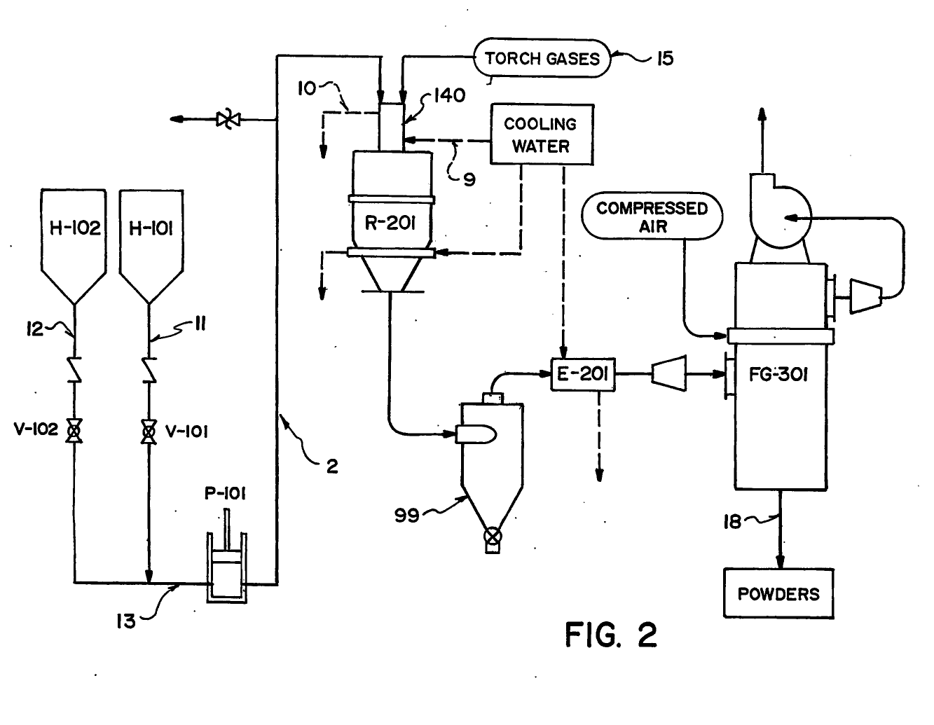

As shown in FIG. 2, liquid feedstock is held in storage vessel H-101. The feedstock may be aqueous-based or organic-based, depending on the desired characteristics of the final nanopowder. Suitable organic solvents include toluene, kerosene, methanol, ethanol, isopropyl alcohol, acetone and the like. Suitable feedstocks include aqueous solutions of metal salts. Aqueous inorganic metal nitrate, carbonate, sulfate, borate, aluminate, phosphate, etc. and organic acetate, methoxide, ethoxide, oxalate, etc. are suitable. Non-aqueous solutions of organometallic compounds may also be used, aqueous solution of aluminum nitrate, alcohol-water solution of aluminum tri-sec butoxide, alcohol-water solution of zirconium n-propoxide, and alcohol-water solution of yttrium nitrate and zirconium n-propoxide. The solution precursors may include organometallic, polymeric, and inorganic salts materials. Preferred inorganic salts are nitrates, chlorides and acetates. The liquid feedstock may be, for example, a solution of dissolved zinc oxide, copper oxide, cerium oxide, magnesium oxide, zirconium oxide, aluminum oxide, zirconium silicon oxide or whatever other suitable material might be the desired constituent of the nanopowder. Since the particle size of the nanopowder or micropowder which is produced will depend on the concentration of the liquid feedstock which is the precursor solution, the concentration of the solution cannot be too high, but also for a reasonable rate of powder production cannot be too low.

The present invention is preferred for producing nanopowders and micropowders for use in thermal spray coatings for fuel cell applications that have a nanostructure. The precursor liquid feedstocks for that purpose are liquid solutions comprising metal nitrates, metal chlorides or other metal halide solutions, and metal organic mixtures. The nanoparticle solutions which are used may comprise alcohol or other organic based solutions with nanoparticles in suspension, such as metal-nitrate solutions. The metal-nitrate solution is reacted with oxygen to produce a metal-oxide ceramic powder. Similarly a metal chloride or other halide based solutions can be used and the metal-chloride or other halide solution is reacted with oxygen to produce and metal-oxide ceramic nanopowders.

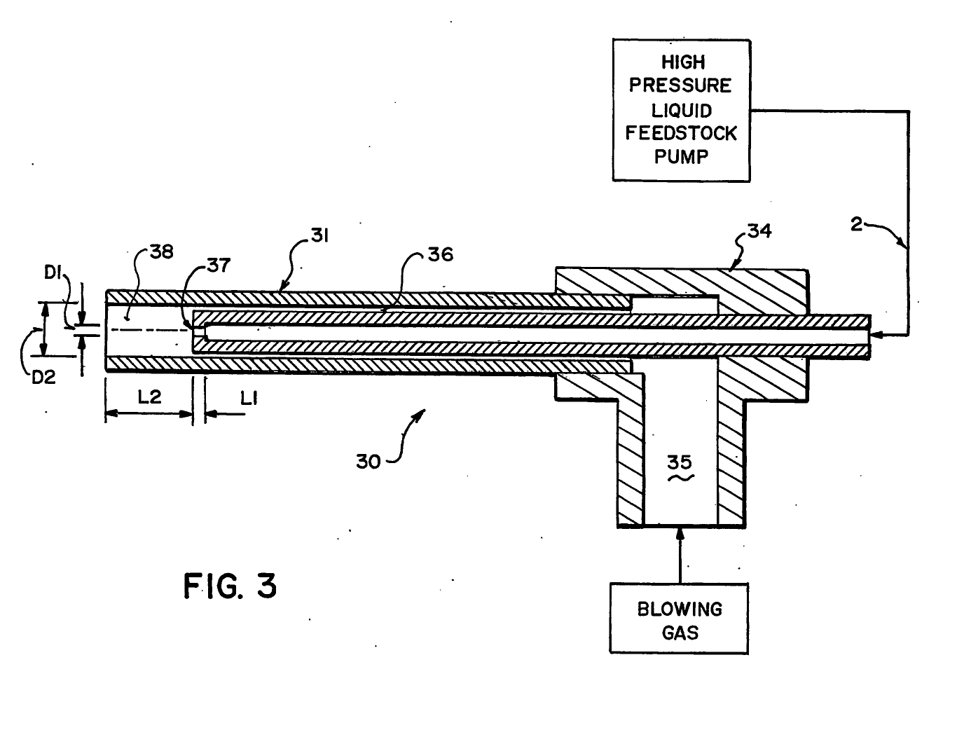

In the embodiment shown in FIG. 2, a second storage vessel H-102 is provided for a water supply for mixing with the feedstock from H-101. Depending on the type of atomizer used, a high-pressure liquid delivery pump P-101 may be used to transport the liquid feedstock through feed line 13 from vessel H-101 through line 11 and valve V-101, and possibly mixed with water from H-102 through line 12 as controlled by valve V-102 to solution feed line 2, and then to the atomizer 30 (FIG. 3). Centrifugal, gear, diaphragm, peristaltic and piston pumps may be used for pump P-101. For a hydraulic atomizer, preferably it provides a pressure of greater than 5,000 psi up to 60,000 psi and a flow rate of at least 0.1 l/minute and preferably up to 1.0 l/min. A suitable peristaltic pump is Instech Laboratories, Inc. model P720/66. A diaphragm pump such as Nikkiso Hydroflo Series 1000, rated 5000 psi and 0.2 dm³/min max flow rate, may also be used. To transport precursors/solvent to the atomizing nozzle for a pneumatic atomizer which does not need a high pressure pump, the diaphragm pump is replaced with a pump operating at approximately 200 to 300 psi in a non-pulsating manner, delivering continuous, homogenous gas/liquid dispersion.

The production rate of powders produced from the precursor solution depends on the concentration of the precursor solution and the feed rate of the solution according to the equation

P=MCV

where P is the powder production rate in grams/hour, M is the molecular weight of the solid in grams/mole; C is the concentration of the solid in the solution in moles/litre; and V is the solution feed rate in litres/hour. The acceptable solution concentration is limited by the size of the required solid particle and the droplet size by the following equation:

d_{P}=0.1[MCₛ/p]^{1/3} d_{d}

where dₚ is the solid particle size (microns), d_{d} is the final droplet size (microns) and p is the density of the solid (g/cm³). For nanopowder production therefore the solution concentration will be much less than 1 mol/litre. To produce powders with diameter less than 100 nm in the present process an atomizer is required to obtain small droplets with narrow size distribution. Ultrasonic, supercritical, electrostatic or jet atomizers may be used.

FIG. 3 illustrates one embodiment of an atomizer 30 for atomizing and delivering liquid feedstock from feed line 2 into the feed tube 31 of axial injection torch 140. The high-pressure liquid delivery pump P-101 delivers high pressure feedstock to generate a high velocity jet of the liquid feedstock from cylindrical orifice 37 which has diameter d₁ and length L₁. The liquid feedstock leaves orifice 37 as a compact jet, and due to the force of collision with the ambient gas, disintegrates into small droplets. Chamber 38, with length L₂ between orifice 37 and the plasma stream is provided to avoid thermal decomposition prior to atomization. A blowing gas is provided through channel 35 of T-shaped connector 34 which flows through circumferential gap 36 between feed tube 31 and feed line 2 to avoid liquid flooding chamber 38 and to provide a relatively low temperature environment in chamber 38. Preferably the diameter d₁ of discharge orifice 37 is between 0.15 and 0.5 mm. Orifice 37 has a diverging exit with an exit angle greater than 15 degrees. The length L₁ of orifice 37 is between 5 and 15 times its diameter. The inlet edge of orifice 37 can be beveled or rounded in order to increase the discharge coefficient to a value that corresponds to a conical orifice with an almost optimum angle between 13 and 14 degrees. L₂ is preferably greater than 10 mm. and the diameter d₂ of chamber 38 is greater than 2 mm. The flow rate of the blowing gas can be around 5 l/min.

FIG. 12-15 illustrate a second embodiment of an atomizer 203 for atomizing and delivering liquid feedstock from feed line 2 into the convergence area of axial injection torch 140. A cross flow, acoustic atomizer as sold under the trademark Ultimix 052H by Hart Environmental Inc, may be adapted for the torch 140. With reference to FIG. 12, atomizer nozzle 201 has a body 202 with central passage 204 which tapers from a conical entry chamber 206 to central aperture 208 to divergent exit port 210. The diameter A of aperture 208 is about 0.052 inches. There are a plurality of injection ports 212 extending radially from the exterior of the nozzle to aperture 208. The diameter of ports 212 will depend on the number of ports, from 0.01 inches to 0.002 inches, with from 4 to 100 such ports. As shown in FIG. 13, an outer tube 214 carries the liquid precursor and inner tube 216 carries the atomizing gas to entry chamber 206. Cap 218 encloses the insert at the end of the outer tube 214. A resonator 221 assists in the atomization by creating a backwardly-directed reflected pressure wave. It consists of two to four flexible stainless steel legs 222 and a central plug 224.

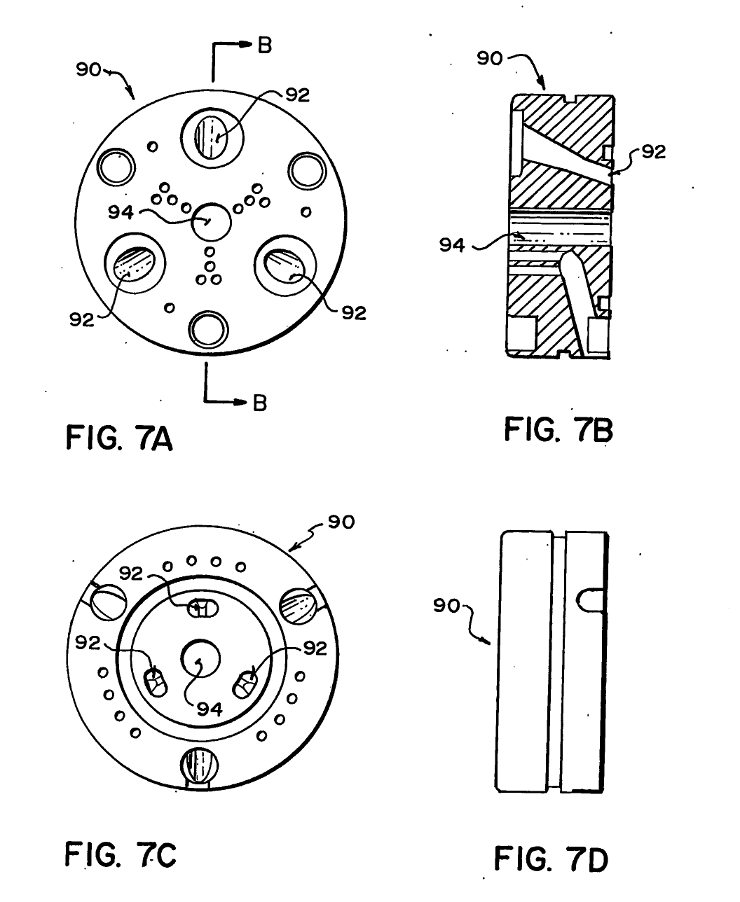

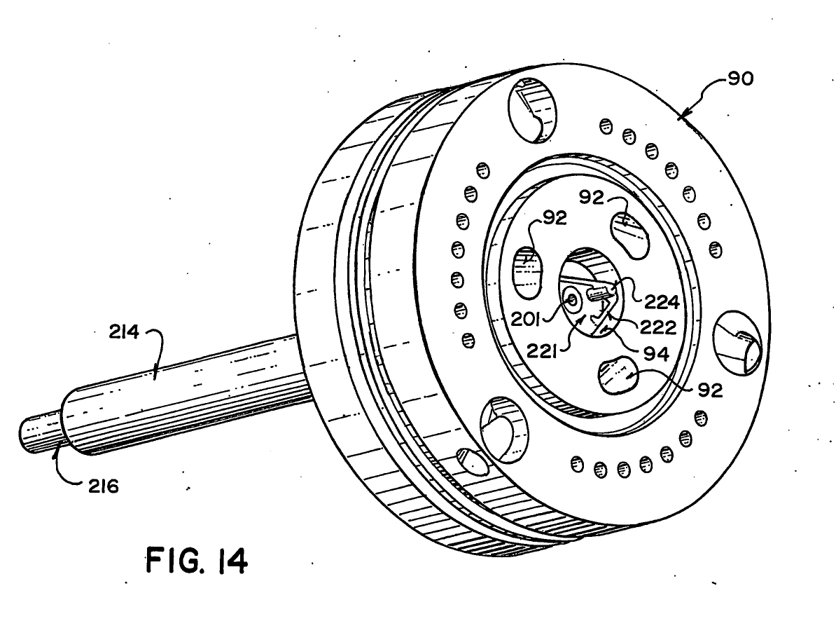

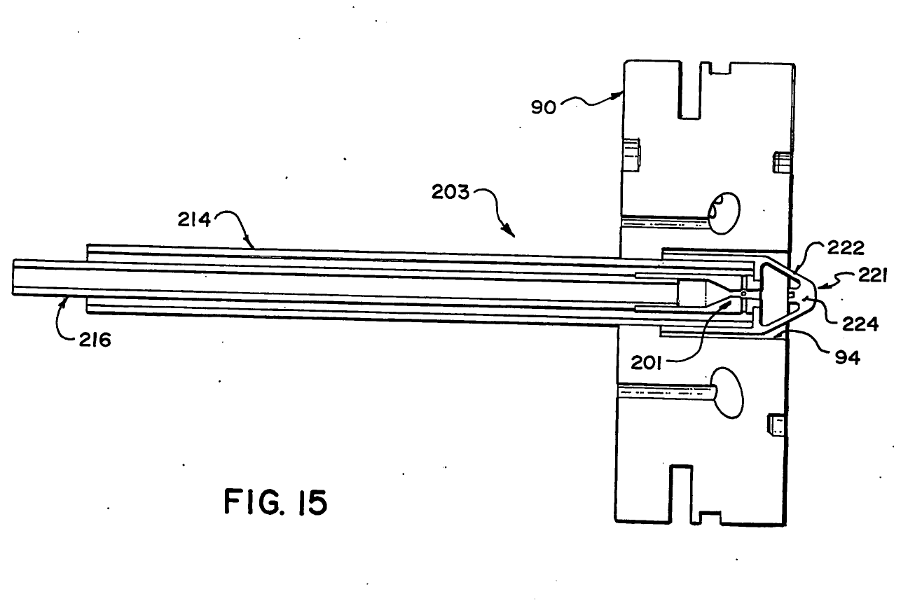

FIGS. 14 and 15 illustrate the atomizer 203 shown in FIG. 12 installed in the convergence blank (reference numeral 90 in FIG. 7) of axial injection torch 140. Convergence blank 90 has three converging channels 92 for the plasma sources, and central axial passage 94 for the liquid feed. Atomizer 203 is retained in central passage 94.

Alternatively an ultrasonic atomizer may be used, such as a 2.4 MHz ultrasonic atomizer with a single or multiple piezoelectric elements. Such atomizers generate water droplets with a mean diameter of 1.7 microns, or smaller where the solution has lower viscosity and surface tension, with atomization rates greater than 1 ml/min. Multiple piezoelectric elements and a high carrier gas flow rate are used for high powder production rate. Suitable nebulizers are manufactured by Sonar Ultrasonics of Farmingdale, N.Y., models 241 and 244. Where an ultrasonic atomizer is used, a high pressure pump is not required for delivering the liquid feedstock.

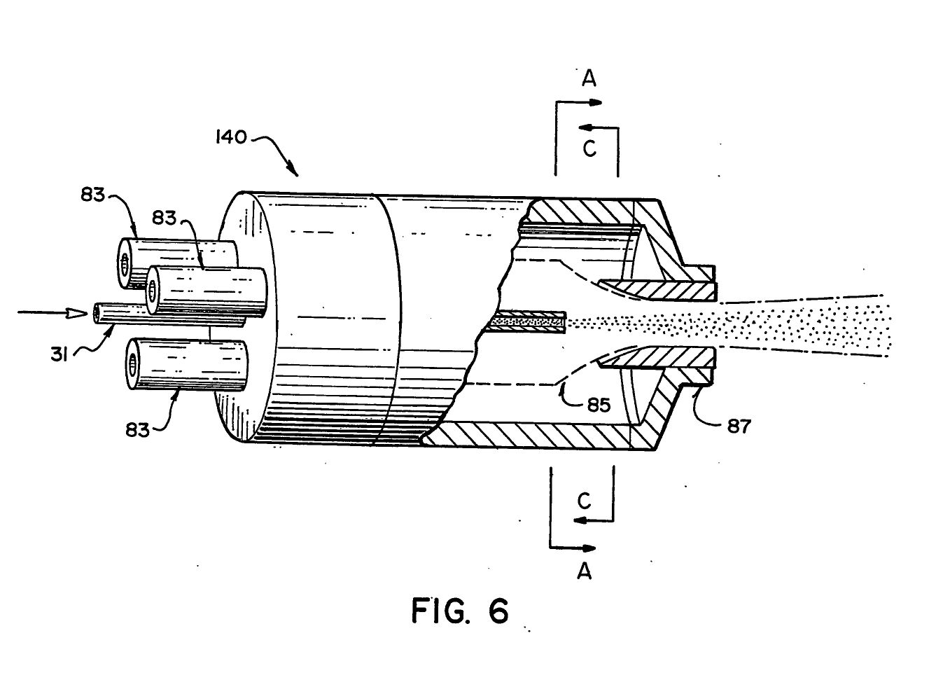

Axial injection plasma torch 140 is preferably a modified Mettech Axial III™, modified to receive the injection and atomization system and feed line 31, as illustrated in FIGS. 6 and 7. Such torches have three plasma sources 83 which converge on the axis of the torch in convergence area or chamber 85, through a convergence blank 90 (FIG. 7). Other axial injection plasma torches which have one or two plasma sources which direct the plasma stream around the axially injected feedstock may also be used. The Mettech Axial III™ torch is scaled up to a 9/16″ nozzle, extended and enlarged to allow for plasma compression from the enlarged convergence.

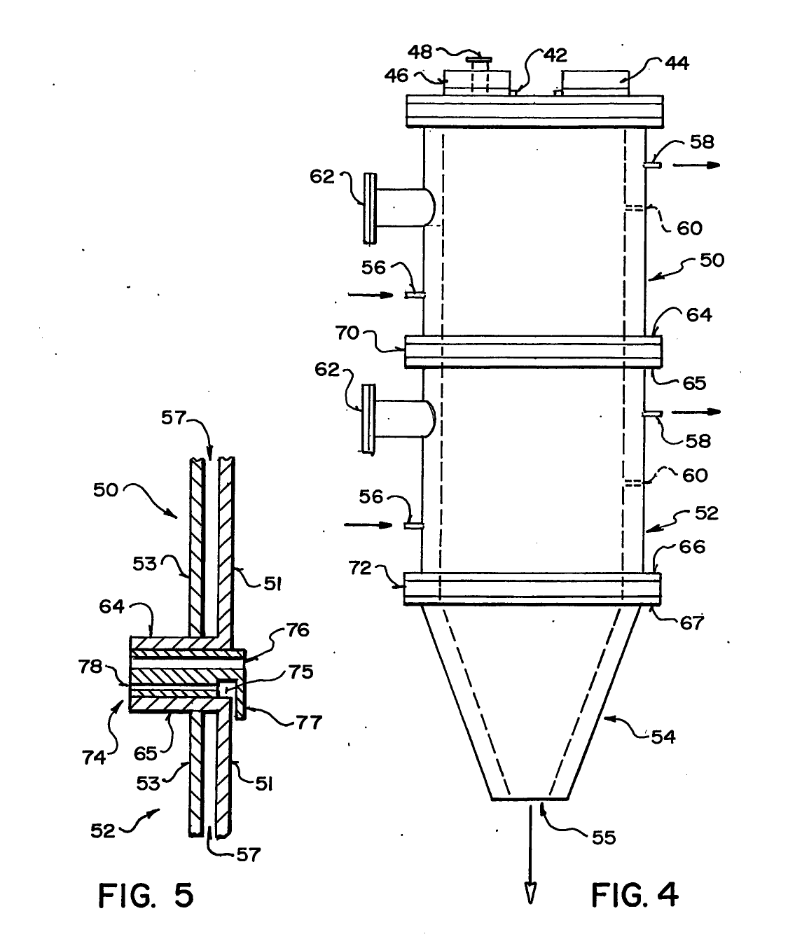

FIG. 7 illustrates a convergence section of the torch where the convergence angle is chosen at 20 degrees, with a ⅜″ diameter axial feed channel 94. Convergence blank 90 has three converging channels 92 for the plasma sources 83, and central axial passage 94 for the liquid feed. Due to the need to receive the atomizer 30 in the axial feed channel 94, torch 140 is modified to provide a wider space between the central passage 94 and convergence channels 92 as shown in FIG. 7C. The nozzle 87 of torch 140 may be wider or longer than usual, and the plasma jet slower, to increase the residence time of the powders in the plasma jet. Components of torch 140 may be constructed of graphite to reduce heat losses within the torch and retain more energy in the plasma jet. The torch 140 is seated in plasma torch adapter seat 42 (FIG. 4) and cooling water is supplied through water supply 9 to cooling plates 44, 46 and out discharge 10. The output of torch 140 extends into reaction chamber R-201.

Reaction chamber R-201 may be constructed of three cylindrical and conical sections 50, 52, 54. (FIG. 4) Each section 50,52 is formed of a hollow steel cylinder having inner and outer walls 51, 53 (FIG. 5) forming a cylindrical space 57 through which cooling water is circulated through water inlets 56 and outlets 58, thereby forming a cooling jacket. Thermocouple ports 60 may be provided for monitoring the temperature in each section as well as a viewing port 62. The chamber R-201 can thereby be instrumented with thermal couples and pressure sensors to monitor and collect the relevant data. Section 50 has a lower flange 64 which connects to flange 65 of section 52 and section 52 has a lower flange 66 which connects to flange 67 of section 54. Annular discs or cooling rings 70, 72 are provided between flanges 64, 65 and 66, 67 to provide injection ports 74 for injection of quenching gas, air or water and reactants. Two types of cooling rings are provided. Each has four straight injection ports 76 (FIG. 5) spaced at 90 degrees, through which quenching gas, air or water can be injected directly into the plasma stream. A first type of cooling ring also has a plurality of ports 76 provided which enter the cylindrical sections at an angle or tangentially, as opposed to radially, so that the quenching gas forms a cyclone around the stream of hot powders. A second type of cooling ring has tangential injection ports 78 through which quenching gas, air or water can be injected. Ports 78 communicate the quenching gas to a concentric channel 75 formed by circular flange 77. The quenching gas is then directed in a circular curtain down the surface of wall 51, to thereby prevent powders from building up on the wall 51. It may also be swirled by angling ports 78 tangentially at an angle to the radius of the cylinders. Preferably chamber R-201 is coated with a thermal barrier coating to reduce heat loses.

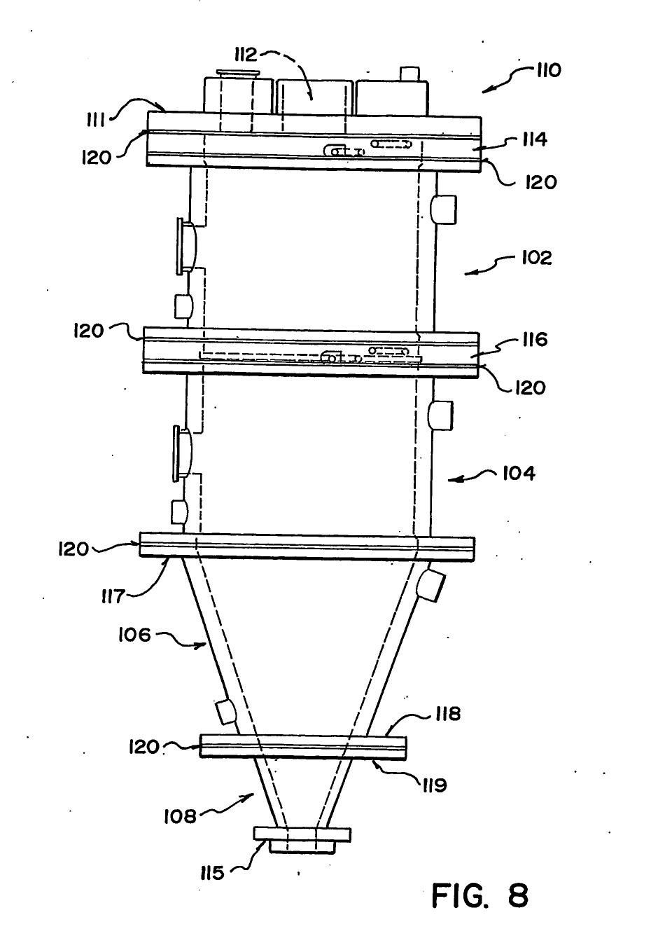

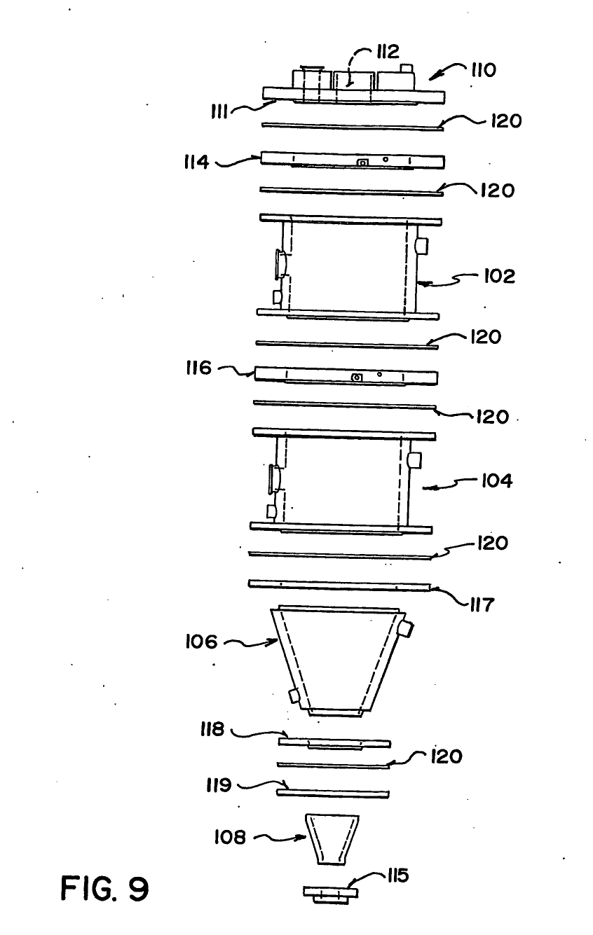

A second embodiment 100 of the reaction chamber R-201 is shown in FIGS. 8 and 9. In this case it is constructed of four sections, cylindrical sections 102, 104, top cone 106 and bottom cone 108, each of which has a cooling jacket provided with a water flow. Top plate 110 has a cooling plate 111 and central passage 112 for receiving torch 140. Cooling ring 114 is provided between top plate 110 and cylinder 102 cooling ring 116 is provided between cylinder 102 and cylinder 104. Top cone top flange 117 is provided between top cone 106 and cylinder 104 and top cone bottom flange 118 and bottom cone bottom flange 119 are provided between top cone 106 and bottom cone 108 and bottom cone bottom flange 115 is provided below bottom cone 108. Gaskets 120 seal between the various flanges. Cooling rings 114, 116 permit quenching materials or reactants to be injected into the plasma flow depending on the process parameters required. Water, air, nitrogen etc. can be used for quenching.

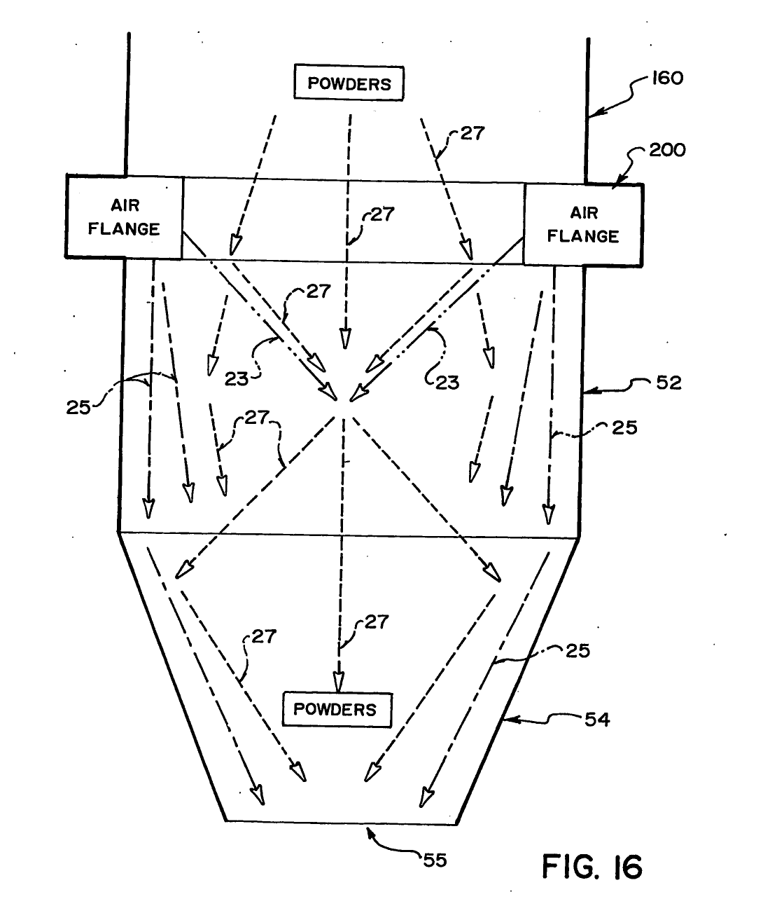

FIG. 16 illustrates the path of the powders 27 in the reaction chamber 180. The nanoparticles have reacted with the plasma gas or oxygen in hot shroud 160 and are first cooled by the quenching air 23 injected in air or gas flange 200, which corresponds to disc 70 in FIG. 4. The quenching air 23 can be injected angularly through port 76 as described above, to cause a cyclonic motion of the air, and may also be angled downwardly to converge the particles to outlet 55 while mixing with the particles to cool them. The curtain of “swirl air” 25 injected through ports 78, as described above, flows along the inner wall of the collection zone to prevent buildup of powders 27 on the walls of the sections, while also quenching the particles. The conical shape of section 54 directs the flow of particles to outlet 55. Swirling of the quench air minimizes turbulence and backflow. The quenching gas can be argon or nitrogen or air.

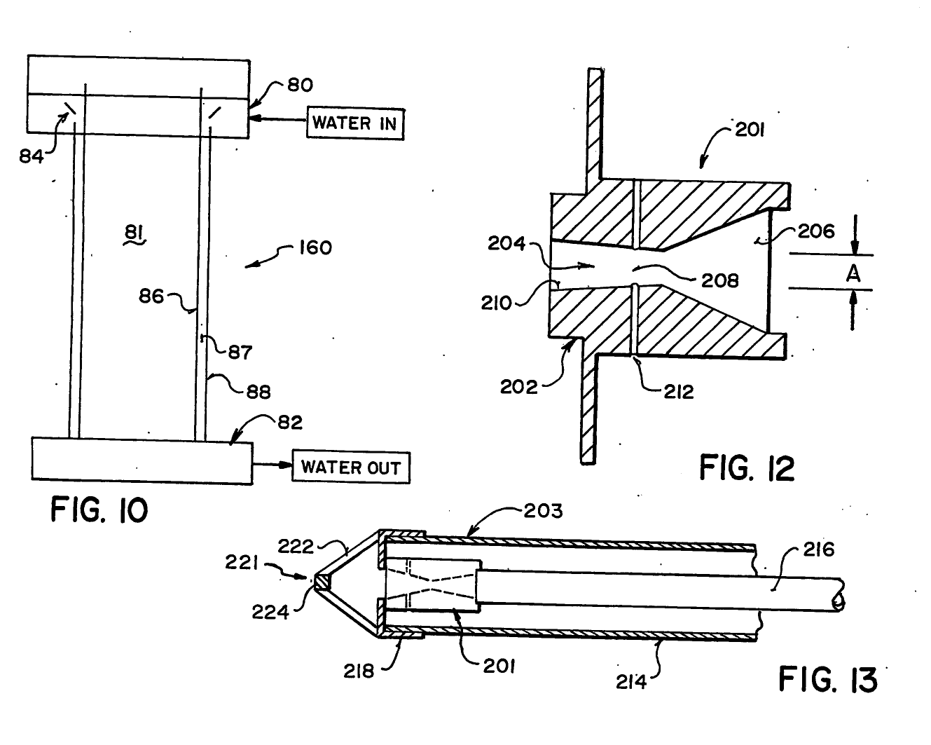

Hot shrouds 160 and 220 may be mounted on the top and bottom of the chamber R-201 and serve to reflect heat back into the particles and extend the residence time in the plasma jet so that the particles react chemically and form a uniform shape. Shroud 220 quenches the flow at the exit of the reaction chamber. The top hot shroud 160 assists in temperature control of the chamber 180 as the initial heat flux to the water cooled hot shroud is quite high and may be of different lengths depending on the application. Lengthening the hot shroud 160 increases the residence time of the particles in the hot stream prior to quenching in order to increase chemical reaction and increase the heat of the particles for a uniform particle shape. The bottom mounted hot shroud 220 is used to quench the exit gas and powders. A suitable design for the hot shroud 160 is illustrated in cross-section in FIG. 10. Hot shroud 160 has central cylindrical passage 81 for the flow of gas within inner cylindrical body 86. A water-in flange 80 provides cooling water through water swirl 84 into space 87 formed between outer cylinder 88 and inner cylinder 86, and out water-out flange 82. Inner cylinder 88 is made from heat resistant material such as ceramic, graphite, zirconia, yttria stabilized zirconia, alumina zirconia, calcia stabilized zirconia, tungsten, molybdenum and stainless steel. Where the inner cylinder is ceramic or graphite, an inert gas is used as coolant. Where the inner cylinder is metal, water is used as coolant.

A shown in FIG. 2 the exit gas may flow through a cooling chamber/heat exchanger E-201 which is cooled by water flowing through coils. A dilution gas may also be injected into the transfer piping at this stage to cool the gas to under 250° C. The cool gas and powder then flows to the powder collection stage. A cyclone may be provided at 99 to commence the separation process.

The powder collection system 240 can be either dry, such as bag filtration, electrostatic separation, membrane filtration, cyclones, impact filtration, centrifugation, hydrocyclones, thermophoresis, magnetic separation or combinations thereof, or powder can be collected in a liquid such as water or oil. See Chaklader et al. U.S. Pat. No. 5,073,193 and Pozarnsky US published patent application no. 20030116228. Preferably a filter cartridge or bag-type dust collector, such as bag filter FG-301 is used. A cyclone 99 may also be used to remove large particles or contaminants. A cyclone has a cylindrical body and a cone with a dust chute connected to a collection bin. The incoming gas spins around the cylindrical body. Heavier particles are thrown to the cyclone walls and slowed by friction. The cone on the bottom of the cyclone causes the slowing air which is dropping to keep the particles against the walls as they drop down by gravity. The particles slide down and exit through a sealed dust chute. At a point inside the cyclone called the neutral point the spinning clean air reverses direction and comes up through the center of the cyclone and exits through the cyclone outlet.

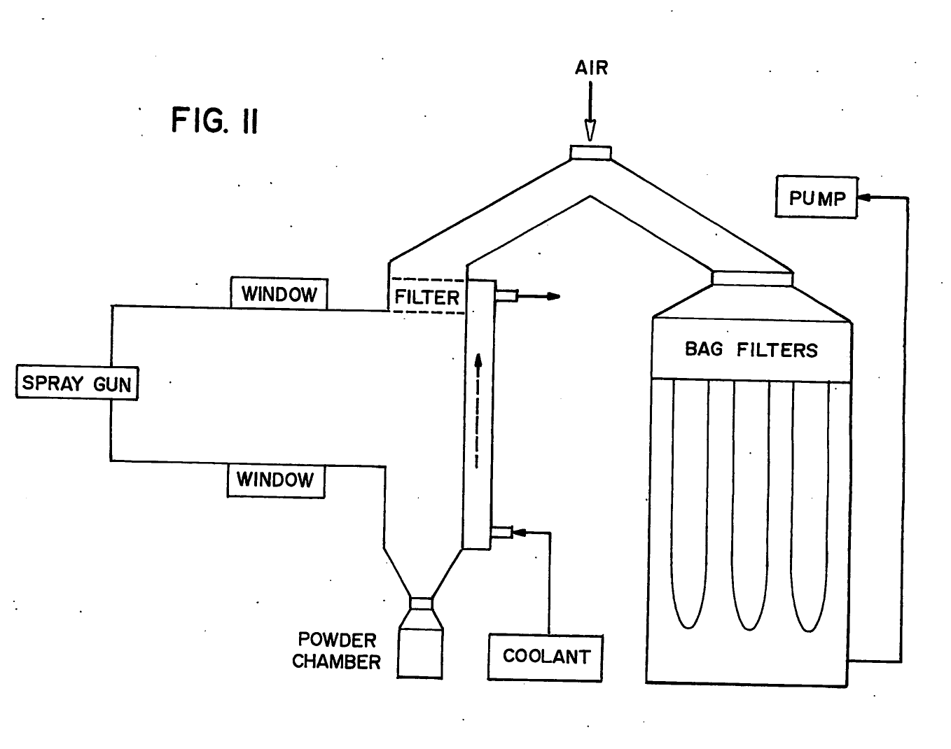

Liquid collection can be also used to quench the powders and prevent agglomeration. Oxides will be collected dry while materials that are oxygen sensitive will be collected in a wet environment. The chamber design may facilitate both means of collection. Multi-bag filters can also be used in combination with a metal fiber fleece filter and cold water as illustrated in FIG. 11.

The key process parameters are i) power level and gas flow rate and gas composition of the plasma torch; precursor feed rate and concentration; atomizing gas flow rate; iv) chamber temperature; v) residence time of powder in plasma; vi) quenching means. The size of said particles in the stream is modified by modifying the concentration of the feedstock solution, feed rate of the feedstock solution, atomizing gas flow rate, plasma power or current and the composition of the plasma gas. The size of said particles in the stream is also modified by modifying the velocity, volume, angle of incidence of and composition of the quenching gas. For example, yttria-stabilized zirconia (YSZ) nanopowders having a particle size of 88 nm were produced using a plasma gas comprising 70%, Argon and 30% Nitrogen and a flow rate of 250 litres per minute, with a ⅜″ nozzle, and electric current in the plasma torch of 125 amperes. The flow rate of the precursor was 50 ml/minute and the 2-fluid atomizer was provided with an air flow of 80 litres per minute @ 45 psi. Yttria-stabilized zirconia (YSZ) nanopowders having a particle size of 95 nm were produced using a plasma gas comprising 70% Argon and 30% Nitrogen and a flow rate of 250 litres per minute, with a 9/16″ nozzle, and electric current in the plasma torch of 125 amperes. The flow rate of the precursor was 150 ml/minute and the 2-fluid atomizer was provided with an air flow of 80 litres per minute @ 45 psi.

The size and shape of the nanoparticles can be varied by controlling the residence time of the particles in the plasma stream before quenching. The residence time determines the particle temperature cooling rate, and whether the chemical reaction of the particles is fully carried out. One way to modify the residence time is through selection of the length of, placement, addition or removal of the hot shroud 160 and cooling rings 114 and 116. The residence time can be increased by increasing the distance between the torch 140 and the quench point. Residence time can be decreased by decreasing the distance between the torch 140 and the quench point. Looking at FIG. 4, the length of cylindrical sections 50 or 52 can be varied depending on where the quenching is to occur. While section 54 is conical, sections 50 and 52 are cylindrical and can be constructed as a plurality of sections depending on how many reaction and quenching zones are required. Quenching or reactant injection can occur in between these sections at discs 70 or 72 and additional annular discs can also be provided between cylindrical sections of the reaction chamber. Referring to FIG. 8, quenching or reactant injection can occur at cooling rings 114, 116 or a third cooling ring can be added between sections 104 and 106, or yet further cooling rings added or cooling ring 116, for example, can be moved to the location just above the bottom cone 106, according to the desired residence time. The residence time is also affected by the power level and gas consumption of the plasma torch and the precursor feed rate.

### Example

A trial was carried out using the atomizer shown in FIG. 3, with the following parameters, using a YSZ (yttria-stabilized zirconia) precursor:
Precursor flow rates: 4.8 ml/min
Precursor concentration: 2.6 M
Plasma parameters:

| | | |
|---|---|---|
| Current | 200 | A |
| Flow | 150 | slpm |

| | |
|---|---|
| Ar (%) | 0 |
| N2 (%) | 100 |
| H2 (%) | 0 |

Particles produced were 6.6 nm particle size.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true scope.

What is claimed is:

1. Method of manufacturing nanopowders or micropowders, comprising:
i) providing an axially injected plasma torch comprising a convergence chamber;
ii) axially delivering a liquid precursor to said plasma torch;
iii) atomizing said liquid precursor prior to delivery to said convergence chamber thereby forming a hot stream of particles in the plasma stream generated by said torch;
iv) introducing said hot stream of particles into a chamber;
v) introducing a quenching gas or liquid into said chamber at a quenching location;
vi) cooling said hot stream of particles and collecting the powder thereby produced.

2. The method of claim 1 wherein said quenching gas or liquid is introduced into said chamber at an angle to the radius of said chamber to thereby form a cyclonic flow.

3. The method of claim 2 wherein said quenching gas or liquid is also introduced as a curtain along the walls of said chamber.

4. The method of claim 1 wherein the particle temperature cooling rate of said particles in said stream is modified by providing a heat shroud between said torch and said quenching location.

5. The method of claim 1 wherein said quenching gas or liquid is introduced into said chamber through a quenching ring and the particle temperature cooling rate of said particles in said stream is modified by adding or subtracting additional quenching rings.

6. The method of claim 1 wherein the particle temperature cooling rate of said particles in said stream before quenching is modified by modifying the distance between the torch and the quenching location.

7. The method of claim 1 wherein the residence time of said particles in said stream is modified by providing a heat shroud between said torch and said quenching location.

8. The method of claim 1 wherein the residence time of said particles in said stream before quenching is modified by modifying the distance between the torch and the quenching location.

9. The method of claim 1 wherein the size of said particles in said stream is modified by modifying the torch parameters selected from the group consisting of gas composition, gas flow and power level.

10. The method of claim 1 wherein the size of said particles in said stream is modified by modifying the atomizing parameters selected from the group consisting of liquid feed rate and atomizing gas flow rate.

11. The method of claim 1 wherein the size of said particles in said stream is modified by modifying the velocity, volume, angle of incidence of and composition of said quenching gas.

12. The method of claim 1 wherein said cooling of said hot stream of particles after introduction of said quenching gas is carried out by adding a stream of cooling gas to said hot stream during transport.

13. The method of claim 1 wherein said quenching gas or liquid is selected from the group consisting of air, argon, nitrogen, carbon dioxide or water.

14. A system for manufacturing nanopowders or micropowders comprising:
i) feed means for delivering a liquid precursor;
ii) an axially injected plasma spray torch comprising a convergence chamber;
iii) atomizing means for atomizing said liquid precursor prior to delivery to said convergence chamber thereby forming a hot stream of particles in the plasma stream generated by said torch;
iv) a chamber for reaction of said hot stream of particles with a quenching gas;
v) means for introducing said quenching gas to said chamber at a quenching location; and
vi) means for collecting the nanopowders or micropowders thereby produced.

15. The system of claim 14 wherein said chamber comprises a variable number of chamber sections.

16. The system of claim 14 wherein said means for introducing said quenching gas to said chamber comprises a variable number of gas-introducing flanges.

17. The system of claim 14 further comprising a hot shroud between said torch and said quenching location.

18. The system of claim 17 wherein said hot shroud comprises:
i) an inner cylinder of a high melting point metal;
ii) an outer cylinder; and
iii) a flow of water provided in the space between said inner and outer cylinders.

19. The system of claim 17 wherein said hot shroud comprises:
i) an inner cylinder of a ceramic or graphite;
ii) an outer cylinder; and
iii) a flow of an inert gas provided in the space between said inner and outer cylinders.

20. The system of claim 18 wherein said inner cylinder is made from a material selected from the group consisting of tungsten, molybdenum and stainless steel.

21. The system of claim 19 wherein said inner cylinder is made from a material selected from the group consisting of graphite, zirconia, yttria stabilized zirconia, alumina zirconia, and calcia stabilized zirconia.
